(19) United States
(12) Patent Application Publication
(10) Pub. No.: US 2015/0003005 A1
(43) Pub. Date: Jan. 1, 2015

(54) ELECTRONIC DEVICE AND DATA STORAGE MODULE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: GUO-YI CHEN, Shenzhen (CN); LEI LIU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/252,469

(22) Filed: Apr. 14, 2014

(30) Foreign Application Priority Data
Jun. 28, 2013 (CN) 2013102640065

(51) Int. Cl. G06F 1/18

(52) U.S. Cl. CPC G06F 1/187
USPC 361/679.33

(57) ABSTRACT

A data storage module includes a carrier, a first hard disk drive, and a second hard disk drive. The carrier includes a bottom plate, a first side plate and a second side plate extending up from two opposite sides of the bottom plate, a top plate extending from a top side of the second side plate toward the first side plate, and a third side plate extending from a distal side of the top plate toward the bottom plate. The first hard drive supported on the bottom plate, and mounted between the first side plate and the second side plate. The second hard disk drive is mounted between the first side plate and the third side plate.

### FIELD

The present disclosure relates to an electronic device with a data storage module.

### BACKGROUND

A server has an enclosure and a number of carriers received in the enclosure. A hard disk drive is installed in a carrier. However, the carrier and the hard disk drive can occupy too much space of the enclosure.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a partially exploded, isometric view of an exemplary embodiment of an electronic device, wherein the electronic device includes a data storage module.

FIG. 2 is an exploded, isometric view of the data storage module of FIG. 1.

FIG. 3 is similar to FIG. 2, but viewed from another perspective.

FIG. 4 is an assembled, isometric view of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one.”

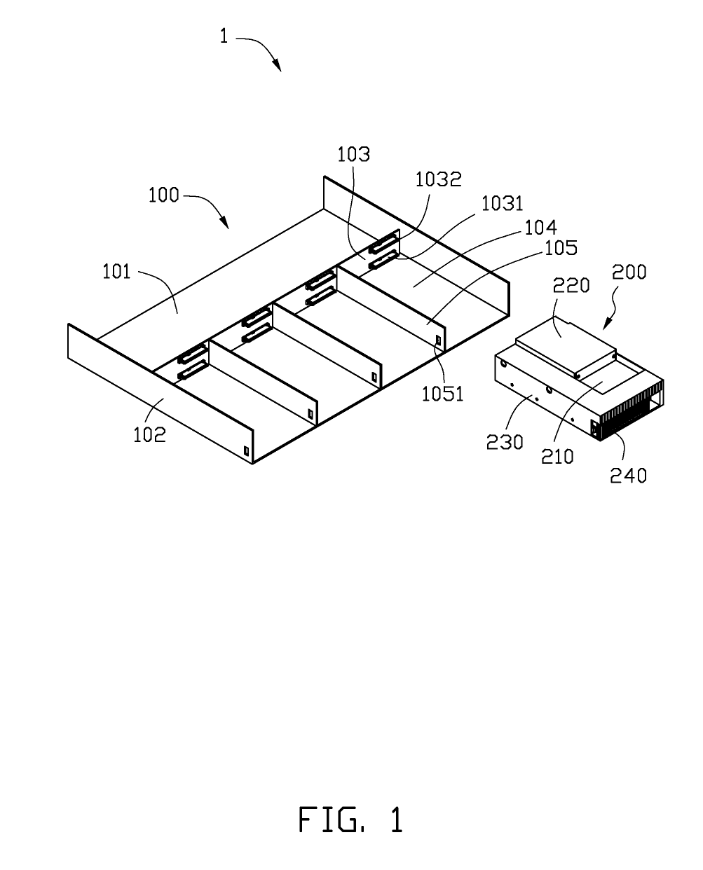

FIG. 1 illustrates an exemplary embodiment of an electronic device 1 comprising a chassis 100 and a data storage module 200 to be received in the chassis 100.

The chassis 100 comprises a bottom wall 101, two sidewalls 102 substantially perpendicularly extending up from two opposite sides of the bottom wall 101, a circuit board 103 mounted on a middle of the bottom wall 101 between the side walls 102, and a plurality of spaced and parallel positioning plates 105 mounted on the bottom wall 101. The circuit board 103 is perpendicular to the sidewalls 102, and the positioning plates 105 are located at a same side of the circuit board 103 and perpendicular to the circuit board 103. The positioning plates 105 and the side walls 102 bound a plurality of receiving spaces 104. A first connector 1031 and a second connector 1032 are longitudinally mounted to the circuit board 103, and received in respective receiving spaces 104. An end of each positioning plate 105 away from the circuit board 103 contains and defines a latching hole 1051 therein.

The data storage module 200 comprises a first hard disk drive 210, a second hard disk drive 220, a carrier 230, and an operation assembly 240 rotatably connected to the carrier 230. A size of the second hard disk drive 220 is smaller than a size of the first hard disk drive 210. In the embodiment shown, the first hard disk drive 210 is 3.5 inch, and the second hard disk drive 220 is 2.5 inch.

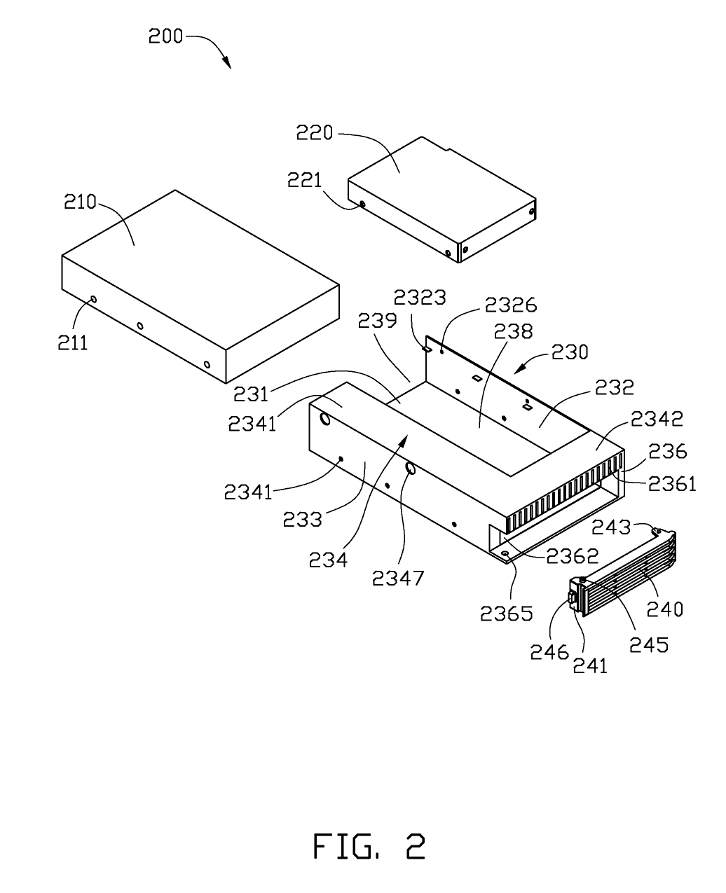

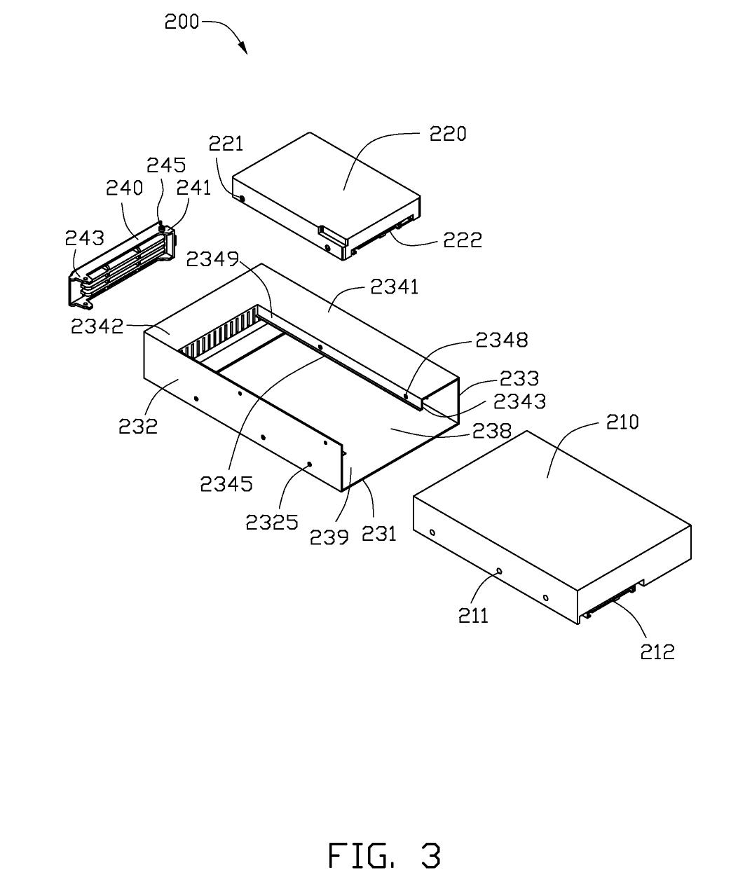

FIGS. 2 and 3 illustrate the data storage module 200. Two opposite sides of the first hard disk drive 210 define a plurality of screw holes 211, and two opposite sides of the second hard disk drive 220 define a plurality of screw holes 221. The first hard disk drive 210 comprises a first plug 212 engaged with the first connector 1031 of the circuit board 103, and the second hard disk drive 220 comprises a second plug 222 engaged with the second connector 1032 of the circuit board 103.

The carrier 230 comprises a bottom plate 231, a first side plate 232 and a second side plate 233 substantially perpendicularly extending up from two opposite sides of the bottom plate 231, an L-shaped top plate 234 perpendicularly connected between the first side plate 232 and the second side plate 233, and an end plate 236 located on a first end of the carrier 230. The bottom plate 231, the first side plate 232, the second side plate 233, the top plate 234, and the end plate 236 bound a receiving space 238. A second end of the carrier 230 defines an opening 239 communicating with the receiving space 238.

The top plate 324 comprises a first plate 2341 extending from a top side of the second side plate 233 toward the first side plate 232, and a second plate 2342 connected between an end of the first plate 2341 and the first side plate 232. The second plate 2342 is adjacent to the end plate 236. A third side plate 2343 perpendicularly extends down from a distal side of the first plate 2341, opposite to the second side plate 233. A flange 2345 perpendicularly protrudes from a distal side of the third side plate 2343 toward the first side plate 232. A plurality of tabs 2323 perpendicularly extends from the first side plate 232 toward the second side plate 233. The tabs 2323 are arranged in a line and aligned with the flange 2345. The flange 2345 is coplanar with the tabs 2323. The third side plate 2343, the flange 2345, the tabs 2323, and the first side plate 232 bound an installing slot 2349 communicating with the opening 239. The first side plate 232 defines a plurality of first mounting holes 2325 adjacent to the bottom plate 231, and a plurality of first installing holes 2326 above the tabs 2323. The second side plate 233 defines a plurality of second mounting holes 2346 adjacent to the bottom plate 231, and a plurality of through holes 2347 aligning with the third side plate 2343. The third side plate 2343 defines a plurality of second installing holes 2348 aligning with the through holes 2347.

The end plate 236 defines a plurality of vents 2361 below the second plate 2342. The end plate 236 defines an installing slot 2362 adjacent to the bottom plate 231, and the installing slot 2362 extends along a lengthwise direction of the end plate 236. An end of the end plate 236 defines two opposite shaft holes 2365 communicating with the installing slot 2362.

The operation assembly 240 comprises a rotating portion 241 located on a first end of the operation member 240 and a resilient latching portion 243 extending out from a second end of the operation member 240. Two opposite shafts 245 protrude out from two sides of the rotating portion 241. A hook 246 protrudes out from an end of the rotating portion 241.

In assembly of the data storage module 200, the first hard disk drive 210 is aligned with the opening 239 with the first plug 212 away from the opening 239. The first hard disk drive 210 is inserted into the receiving space 238 of the carrier 230 from the opening 239, until the screw holes 211 of the first hard disk drive 210 aligning with the first mounting holes 2325 of the first side plate 232 and the second mounting holes 2346 of the second side plate 233. A plurality of screws extend through the first and second mounting holes 2325 and 2346, to mount in the screw holes 211 of the first hard disk drive 210. The second hard disk drive 220 is aligned with the installing slot 2349 with the second plug 222 away from the opening 239. The second hard disk drive 220 is inserted into the installing slot 2349 from the opening 239, until the screw holes 221 of the second hard disk drive 220 aligning with the first installing holes 2326 of the first side plate 232 and the second installing holes 2348 of the third side plate 2343. A plurality of screws extend through the first installing holes 2326 of the first side plate 232 and the through holes 2347 of the second side plate 233 and the second installing holes 2348 of the third side plate 2343, to mount in the screw holes 221 of the second hard disk drive 220. The rotating portion 241 is received in the installing slot 2362, the shafts 245 are rotatably inserted in the shaft holes 2365. The latching portion 243 is detachably latched to the two opposite side surfaces of the installing slot 2362. When the latching portion 243 latches the two opposite side surfaces of the installing slot 2362, the hook 246 extends out the second side plate 233.

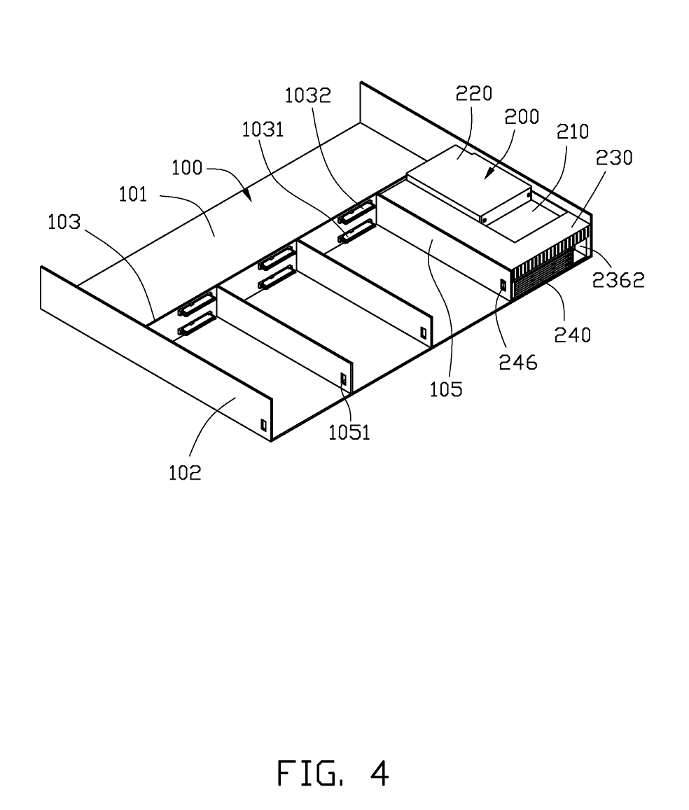

FIG. 4 illustrates an assembled electronic device 1 with the data storage module 200 aligned with one of the receiving spaces 104, with the first plug 212 aligned with the first connector 1031 and the second plug 222 aligned with the second connector 1032. The operation assembly 240 is rotated, and the hook 246 is received in the installing slot 2362. The data storage module 200 is inserted in the receiving space 104, until the first plug 212 is electrically coupled to the first connector 1031 and the second plug 222 is electrically coupled to the second connector 1032. The operation assembly 240 is rotated, the hook 246 is located in the latching hole 1051 of the corresponding position plate 105, and the latching portion 243 is latched to the carrier 230. Thereby, the data storage module 200 is installed in the chassis 100. The carrier 230 is capable of retaining the first hard disk drive 210 and second hard disk drive 220 simultaneously. A space in the chassis 100 is saved.

To detach the data storage module 200 from the carrier 230, the operation assembly 240 is rotated, until the hook 246 is detached from the latching hole 1051. Thereby, the data storage module 200 can be moved out and detached from the carrier 230.

While the disclosure describes examples and embodiments, it is to be understood that the disclosure is not limited thereto. To the contrary, the disclosure is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A data storage module, comprising:
a carrier comprising a bottom plate, a first side plate and a second side plate extending up from two opposite sides of the bottom plate, a top plate extending from a top side of the second side plate toward the first side plate, and a third side plate extending from a distal side of the top plate toward the bottom plate;
a first hard disk drive supported on the bottom plate and mounted between the first side plate and the second side plate; and
a second hard disk drive mounted between the first side plate and the third side plate.

2. The data storage module of claim 1, wherein the carrier further comprises a flange extending from a bottom side of the third side plate toward the first side plate and a plurality of tabs protruding out from the first side plate toward the second side plate, the flange is coplanar with the tabs, the second hard disk drive is supported on the flange and the tabs.

3. The data storage module of claim 2, wherein the bottom plate, the first side plate, and second side plate cooperatively bound a receiving space for receiving the first hard disk drive.

4. The data storage module of claim 2, wherein the first side plate, the third side plate, the flange, and the tabs cooperatively bound an installing slot for receiving the second hard disk drive.

5. The data storage module of claim 2, wherein two opposite sides of the first hard disk drive define a plurality of screw holes therein, the first side plate defines a plurality of first mounting holes, the second side plate defines a plurality of second mounting holes, a plurality of screws extends through the first and second mounting holes for securement in the screw holes of the first hard disk drive.

6. The data storage module of claim 2, wherein two opposite sides of the second hard disk drive defines a plurality of screw holes therein, the first side plate defines a plurality of first installing holes above the tabs, the second side plate defines a plurality of second installing holes above the flange, a plurality of screws extends through the first and second installing holes for securement in the screw holes of the second hard disk drive.

7. The data storage module of claim 6, wherein the second side plate defines a plurality of through holes aligning with the second installing holes, the corresponding screws are extended through the plurality of through holes.

8. The data storage module of claim 1, further comprising an operating assembly for mounting the data storage module, wherein the carrier further comprises an end plate located on a first end of the carrier, the operating assembly is rotatably installed to the end plate.

9. The data storage module of claim 8, wherein the end plate defines a plurality of vents.

10. An electronic device, comprising:
a chassis comprising a bottom wall, two sidewalls extending up from two opposite sides of the bottom wall, a circuit board mounted on the bottom wall between the sidewalls, and a plurality of spaced and parallel positioning plates mounted on the bottom wall and located at a same side of the circuit board, wherein the positioning plates and the side walls bound a plurality of receiving spaces, the circuit board comprises a first connector and a second connector received in each receiving space; and
a plurality of data storage modules received in the receiving spaces of the chassis;
wherein each data storage module comprises a carrier received in the corresponding receiving space, a first hard disk drive, and a second hard disk drive, the carrier comprises a bottom plate, a first side plate and a second side plate extending up from two opposite sides of the bottom plate, a top plate extending from a top side of the second side plate toward the first side plate, and a third side plate extending from a distal side of the top plate toward the bottom plate;
the first hard disk drive is supported on the bottom plate and mounted between the first side plate and the second side plate, and comprises a first plug coupled to the first connector;
the second hard disk drive is mounted between the first side plate and the third side plate, and comprises a second plug coupled to the second connector.

11. The electronic device of claim 10, wherein the carrier further comprises a flange extending from a bottom side of the third side plate toward the first side plate and a plurality of tabs protruding out from the first side plate toward the second side plate, the flange is coplanar with the tabs, the second hard disk drive is supported on the flange and the tabs.

12. The electronic device of claim 11, wherein the bottom plate, the first side plate, and second side plate cooperatively bound a receiving space for receiving the first hard disk drive.

13. The electronic device of claim 11, wherein the first side plate, the third side plate, the flange, and the tabs cooperatively bound an installing slot for receiving the second hard disk drive.

14. The electronic device of claim 11, wherein two opposite sides of the first hard disk drive define a plurality of screw holes therein, the first side plate defines a plurality of first mounting holes adjacent to the bottom plate, the second side plate defines a plurality of second mounting holes, a plurality of screws extends through the first and second mounting holes for securement in the screw holes of the first hard disk drive.

15. The electronic device of claim 11, wherein two opposite sides of the second hard disk drive defines a plurality of screw holes therein, the first side plate defines a plurality of first installing holes above the tabs, the second side plate defines a plurality of second installing holes above the flange, a plurality of screws extends through the first and second installing holes for securement in the screw holes of the second hard disk drive.

16. The electronic device of claim 15, wherein the second side plate defines a plurality of through holes aligning with the second installing holes, the corresponding screws are extended through the plurality of through holes.

17. The electronic device of claim 10, wherein each data storage module further comprises an operation assembly opposite to the circuit board, the operation assembly comprises a rotating portion located on a first end of the operation member, a resilient latching portion extending out from a second end of the operation member, and a hook protrudes out from the rotating portion, the rotating portion is rotatably connected to an end of the carrier, the latching portion is latched to the carrier, and the hook is latched to the corresponding positioning plate.

18. The electronic device of claim 17, wherein each positioning plate defines a latching hole and the hook is latched in the latching hole.

19. The electronic device of claim 17, wherein the carrier defines two opposite shaft holes, the operation assembly comprises two opposite shafts extending from the rotating portion to insert in the shaft holes.
